(19) United States
(12) Patent Application Publication
(10) Pub. No.: US 2012/0018969 A1
(43) Pub. Date: Jan. 26, 2012

(54) MULTI-PURPOSE BOARD

(75) Inventor: Jae Young CHO, Bucheon-si (KR)

(73) Assignee: DODAM MS Co., LTD., Incheon-si (KR)

(21) Appl. No.: 13/186,608

(22) Filed: Jul. 20, 2011

(30) Foreign Application Priority Data
Jul. 20, 2010 (KR) 10-2010-0069852

(51) Int. Cl. B62M 1/00

(52) U.S. Cl. 280/87.041

(57) ABSTRACT

Provided is a novel multi-purpose board that can be driven by means of a user pushing against the ground with his/her feet and moving his/her body. The multi-purpose board is configured as a new type of exercise apparatus by combining a kickboard type exercise apparatus that can be propelled forward by pushing against the ground with one foot, and an S-board or tri-board type exercise apparatus that is moved forward by placing each foot on a board and moving the legs, buttocks, and waist, and also both arms. Thus, a user is able to selectively enjoy a kickboard, an S-board, or a tri-board according to need, and derive more pleasure, a better sense of balance, and exercise for the entire body. The multi-purpose board employs a foldable structure allowing a handlebar that projects outward to either side to be folded downward, and also an upright steering column to be folded back against a board plate, thus allowing the overall volume and size of the board to be minimized so that the multi-purpose board can not only be stored and maintained easily, but also conveniently carried.

### CROSS-REFERENCE TO RELATED APPLICATIONS

This U.S. non-provisional patent application claims priority under 35 U.S.C. §119 of Korean Patent Application No. 10-2010-0069852, filed on Jul. 20, 2010, the entire contents of which are hereby incorporated by reference.

### BACKGROUND

The present disclosure herein relates to a multi-purpose board, and more particularly, to a novel multi-purpose board that can be driven by means of a user pushing against the ground with his/her feet and moving his/her body.

People in modern society have recently begun to have growing interest in their health, and thus, many health-related apparatuses are being developed.

From among such exercise apparatuses, there are a particularly large number of exercise apparatuses that provide the enjoyment of speed while exercising.

One such exercise apparatus that provides the enjoyment of speed while exercising is the kickboard type exercise apparatus.

The kickboard type exercise apparatus is provided with a wheel at both the front and rear of a floor board on which a user places his/her feet, and also a handle for a user to grasp with his/her hands to steer a wheel.

However, because a kickboard type exercise apparatus involves the need to push against the ground with one's feet to generate motive force, not only is motive force limited, but there is the inconvenience of having to constantly push against the ground.

Also, as an improvement upon the kickboard type exercise apparatus, there is the S-board type skate board which may be moved forward by means of directional casters, without having to push against the ground with the feet.

The skate board has wheels configured as directional casters, and has a front plate and rear plate connected with a torsion bar. When twist or bending occurs between the front plate and rear plate, the resilient force exerted by the torsion bar is used to propel the exercise apparatus forward.

However, an S-type skate board requires a user to position his/her center of gravity at the rear and maintain balance, which is a limitation that makes it difficult for beginners to ride the apparatus.

The tri-board type exercise apparatus, which trains the leg muscles and may improve one's sense of balance, has attracted much attention recently.

The tri-board type exercise apparatus is configured with a front column with a wheel at the bottom thereof and a handlebar at the top thereof, and 2 trailing bars hinge-coupled to the front column and each having a wheel so as to laterally open or close at the same time. A user grips the handlebar with both hands, places each foot on a footboard of the left and right trailing bars, respectively, and moves forward by spreading or closing his/her legs.

However, because the tri-board type exercise apparatus uses a method of moving forward by means of the force exerted by a user in spreading or closing his/her legs while standing on the footboards, while leg muscle force can be strengthened by using both legs, the apparatus has virtually no effectiveness in developing a sense of balance and is also bulky in overall volume, so that the apparatus is difficult to store and maintain and is inconvenient to carry.

### SUMMARY

The present disclosure provides a multi-purpose board that is configured as a new type of exercise apparatus by combining a kickboard type exercise apparatus that can be propelled forward by pushing against the ground with one foot, and an S-board or tri-board type exercise apparatus that is moved forward by placing each foot on a board and moving the legs, buttocks, and waist, and also both arms. Thus, a user is able to selectively enjoy a kickboard, an S-board, or a tri-board according to need, and derive more pleasure, a better sense of balance, and exercise for the entire body.

The present disclosure also provides a multi-purpose board that employs a foldable structure allowing a handlebar that projects outward to either side to be folded downward, and also an upright steering column to be folded back against a board plate, thus allowing the overall volume and size of the board to be minimized so that the multi-purpose board can not only be stored and maintained easily, but also conveniently carried.

Embodiments of the present invention provide multi-purpose boards including: a steering unit, being a member for controlling a direction of a front wheel pivoting shaft to change a travelling direction of the multi-purpose board, and including a handlebar at a top thereof, a front wheel at a bottom thereof, and a steering column pivotably inserted in a board plate-end stand; and a board plate, being a portion upon which a user positions feet for riding, and including a rear board plate having a rear wheel capable of rotating 360° with respect to a front board plate connected to the stand, and a spring connecting the front board plate and the rear board plate in-line from front to rear and for enabling forward movement of the multi-purpose board by means of being twisted and restored. With both hands grasping the handlebar and both feet positioned on the board plate, a user may ride the multi-purpose board by moving his/her legs or moving his/her buttocks, waist, and both arms.

In some embodiments, the handlebar at both sides of the steering unit may be coupled as a hinged structure to the steering column via the resilient stopper so as to be foldable downward to be parallel along both sides of the steering column.

In other embodiments, the spring connecting the front board plate and the rear board plate may be configured of a plurality of stacked sheets of elongated bar-shaped leaf springs, so as to provide good twisting and restoring action.

In still other embodiments, the board plate and the stand may be coupled with a hinge pin, the stand may be received between a pair of guide walls installed on the board plate and having arcuate slots, and the steering unit including the stand may be entirely foldable against the board plate, by virtue of being guided by a locking pin that may pass through the guide walls and the stand and move along the slots, such that the steering unit may be foldable forward and backward, thus allowing the overall volume of the multi-purpose board to be minimized for storage or carry.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view of a multi-purpose board according to an embodiment of the present invention;

FIG. 2 is a frontal view of a multi-purpose board according to an embodiment of the present invention;

FIG. 3 is a plan view of a multi-purpose board according to an embodiment of the present invention;

FIG. 3 is a side view of a multi-purpose board according to an embodiment of the present invention;

FIG. 5 is a sectional view illustrating the overall internal structure of a multi-purpose board according to an embodiment of the present invention;

FIG. 6 is a sectional view of FIG. 5 taken along line A-A;

FIG. 7 is a sectional view of FIG. 5 taken along line B-B;

FIG. 8 is a sectional view of FIG. 5 taken along line C-C;

FIG. 9 is a schematic view illustrating folded and open states of a handlebar of a multi-purpose board according to an embodiment of the present invention; and

FIG. 10 is a plan view illustrating a multi-purpose board being used according to an embodiment of the present invention.

### DETAILED DESCRIPTION OF THE EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

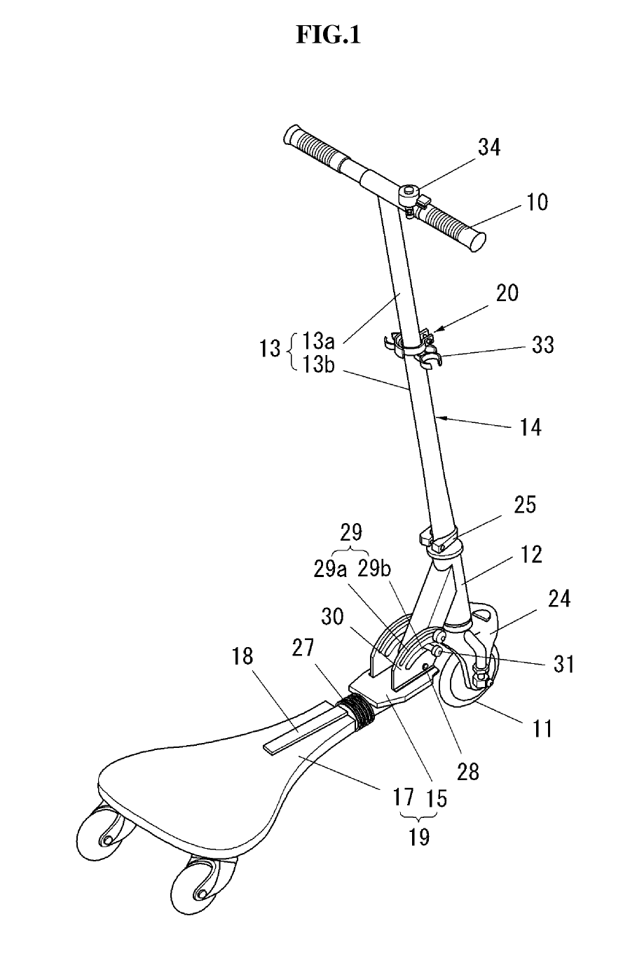

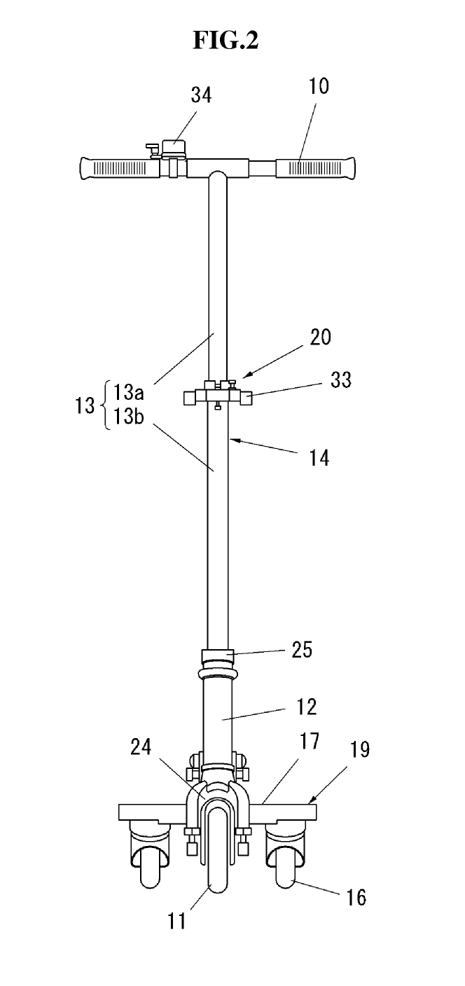

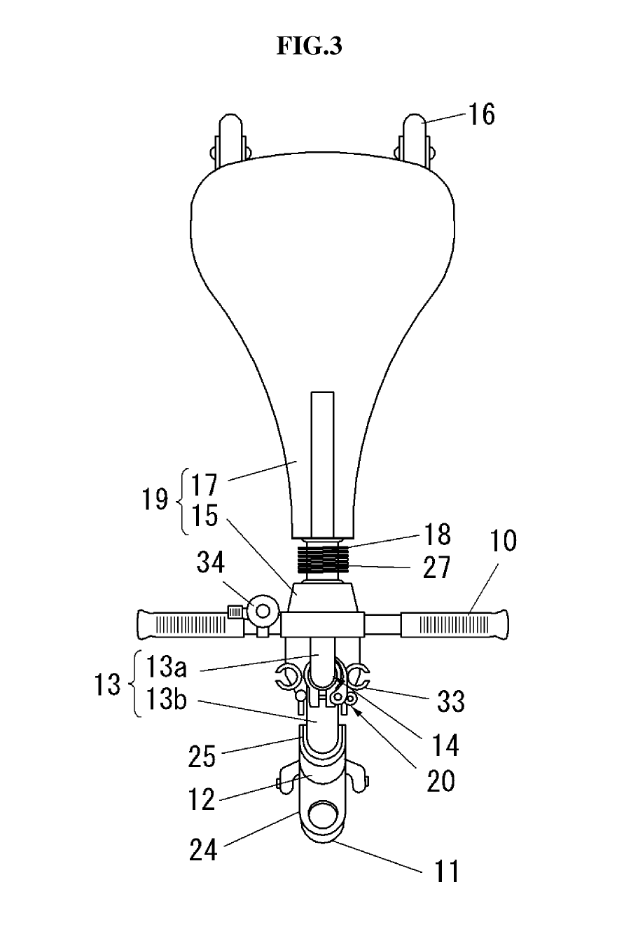

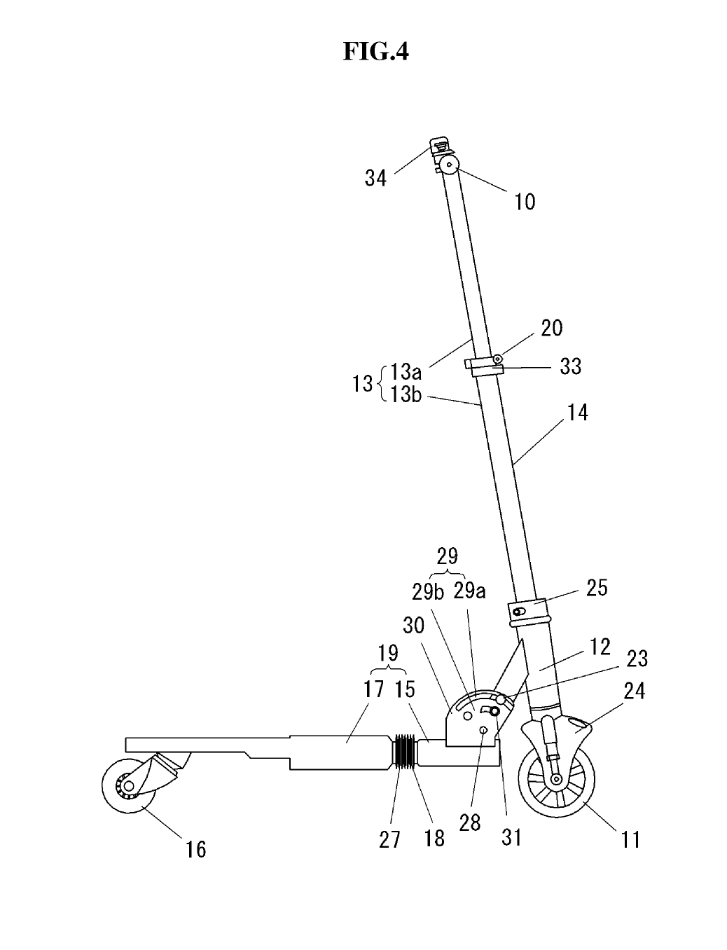

FIGS. 1 to 4 are perspective, frontal, plan, and side views of a multi-purpose board according to an embodiment of the present invention.

Referring to FIGS. 1 to 4, the multi-purpose board combines the benefits of a kickboard type exercise apparatus that can be propelled forward by pushing against the ground with one foot, and an S-board or tri-board type exercise apparatus that is moved forward by placing each foot on a board and moving the legs, buttocks, and waist, and also both arms. Thus, the fun of riding a board and also, exercise of the entire body can be more effectively derived.

For this end, the multi-purpose board includes steering unit 14 with a handlebar 10 at either side that a user can grasp with his/her hands to change the travelling direction of the board, and a board plate 19 divided into 2 parts being a front board plate 15 and rear board plate 17, which are connected integrally by a spring 18. A front wheel 11 is provided at the bottom of the steering unit 14, and 2 rear wheels 16 are provided to rotate 360° at the rear of the board plate 19.

Here, reference numeral 33 not described is a handle holder for fixing the handlebar 10 in a folded state, and reference numeral 34 is a bell for sounding a warning to pedestrians.

Accordingly, a user may grasp the handlebar 10 with both hands and push against the ground with one foot while the other foot is positioned on the board plate 19, in order to move forward, or may position both feet on the board plate 19 and undulate the buttocks, thighs, etc. to move forward.

In addition, after acceleration is achieved by using the lower body, one can travel forward by rowing the handlebar 10 laterally.

In this manner, the multi-purpose board is configured as a combination of a kickboard, S-board, and tri-board, and enables a user to selectively enjoy a kick board, S-board, and tri-board, according to need.

The structure, operating principles, and riding method of the multi-purpose board will be described in further detail.

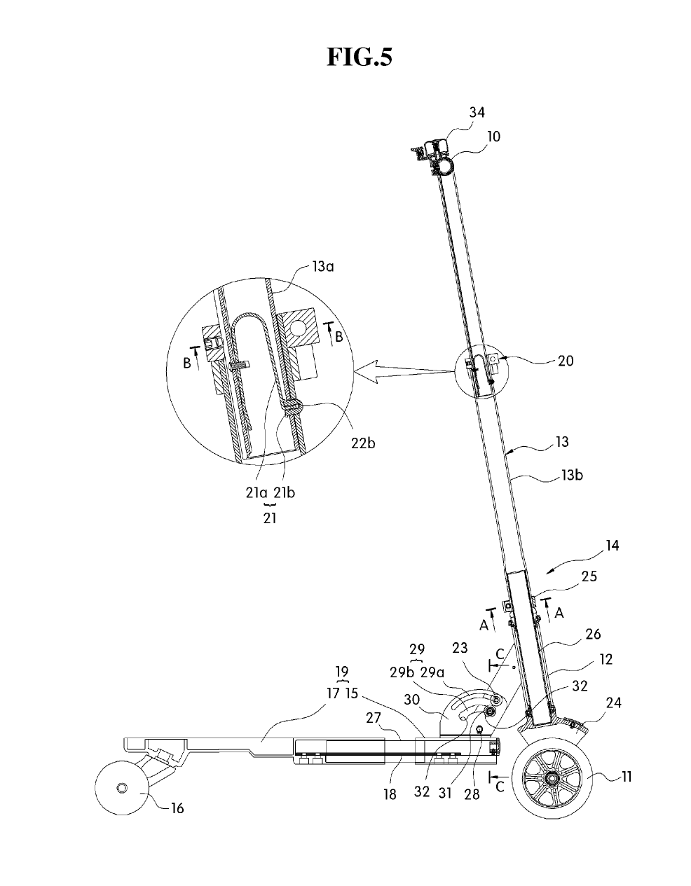

FIG. 5 is a sectional view illustrating the overall internal structure of a multi-purpose board according to an embodiment of the present invention.

Referring to FIG. 5, the multi-purpose board includes a steering unit 14 that is means for controlling the pivoting direction of the front wheel in order to change the travelling direction of the board.

The steering unit 14 includes a hollow pipe-shaped steering column 13 formed of an upper steering column 13a and a lower steering column 13b that are coupled through fitting one into the other, 2 handlebars 10 installed at either side at the top end of the upper steering column 13a, a front wheel 11 installed at the bottom of the lower steering column 13b, etc. When a user grasps the handlebar 10 at either side with both hands and alternately undulates either side in a rowing motion, the entire steering column 13 including the front wheel 11 is designed to pivot.

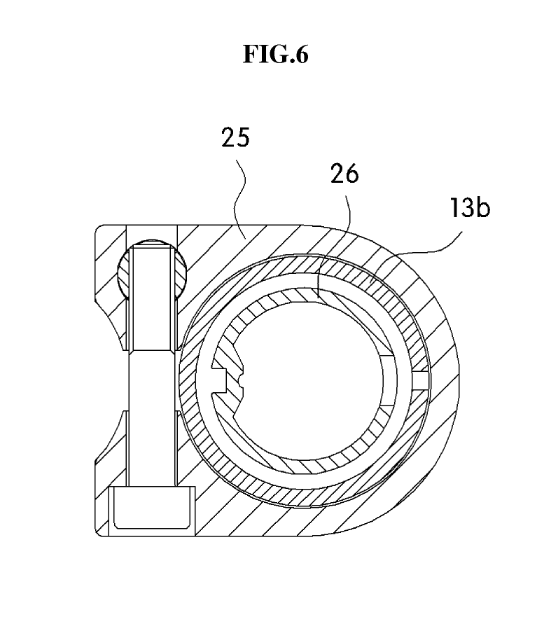

This steering column 13 is supported through a pivoting shaft 26 provided in the lower steering column 13b and connected to the front wheel 11—for example, the pivoting shaft 26 is concentrically coupled within the stand 12 connected to a board plate 19 (to be henceforth described) and supported at the top and bottom by two bearings. Connected at the upper end of the thus-coupled pivoting shaft 26, as shown in FIG. 6, is a clamp 25 that is inserted in the lower end of the lower steering column 13b to constrict the periphery of the lower steering column 13b.

Thus, when a user moves the handle 10, the steering column 13 constituted of the upper steering column 13a and lower steering column 13b is capable of pivoting around the pivoting shaft 26 disposed in a pivotable configuration in the stand 12, and is ultimately capable of changing the direction of the front wheel 11 coupled integrally to the pivoting shaft 26.

Also, the steering column 13 of the steering unit 14 may be extended in length for use, and may be reduced in length for storage or carry.

For this end, the upper steering column 13a is coupled to the lower steering column 13b in an inserted manner to allow storage and extraction, so that the upper steering column 13a may be outwardly extracted from or inserted into the lower steering column 13b when needed. In these cases, in order to maintain the stored or extracted state, a lock/unlock device 20 is installed on the top end of the lower steering column 13b.

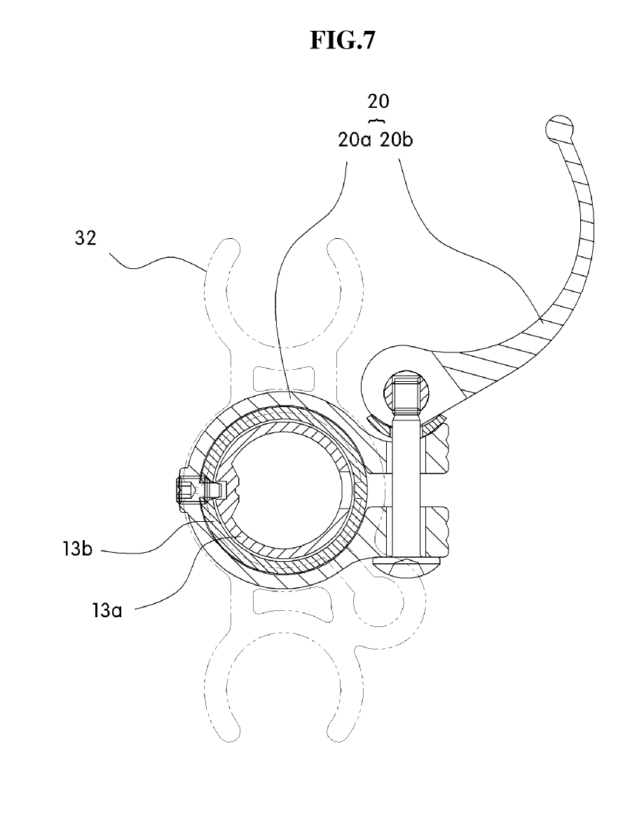

The lock/unlock device 20, as shown in FIG. 7, includes a tightening ring 20a having an open portion on one side for being mounted around the lower steering column 13b, and a lever 20b using a lever structure to tighten the open portion of the tightening ring 20a.

Accordingly, when the lever 20b of the lock/unlock device 20 is pressed to one side to loosen the opening of the tightening ring 20a, extraction or storage of the upper steering column 13a is possible; and when the extraction or storage of the upper steering column 13a has been completed, the lever 20b is pressed to the other side to constrict the opening of the tightening ring 20a so that the upper steering column 13a and the lower steering column 13b are tightly fastened by the tightening ring 20a, and the stored or extracted state of the upper steering column 13a may be fixed.

Of course, for the tightening and loosening function of the lock/unlock device 20, a steering column configured as a pipe with certain open sections along the length of a side thereof may be implemented.

Further, a resilient stopper 21 is provided on the steering unit 14 to determine the topmost position to which the upper steering column 13a may be extracted. Accordingly, a user does not experience the inconvenience of having to check the extracted degree of the upper steering column 13a, and is provided with the convenience of being able to easily adjust the extracted degree of the upper steering column to a suitable level by means of the resilient stopper 21.

For this end, the resilient stopper 21 is installed within the pipe of the upper steering column 13a and configured of a spring member 21a bent in an approximate U-shape for imparting tension in a straightening direction thereof, and a hinge pin member 21b attached to one end of the spring member 21a.

Accordingly, when the upper steering column 13a is extracted, the hinge pin member 21b that always receives the tension exerted by the spring member 21a in an outward direction slides along the inner pipe surface and is inserted with a “click” into a hole 22b in the upper end of the lower steering column 13b, at which point the upper steering column 13a has been extracted to a suitable height (length). In this state, the lock/unlock device 20 is manipulated to fasten the upper steering column 13a to the lower steering column 13b and configure the steering column 13 to a ready-to-use state.

The handlebar 10 at both sides of the steering unit 14 is provided in a folding and unfolding configuration, so that interference from the handlebar 10 can be reduced during storage or carry.

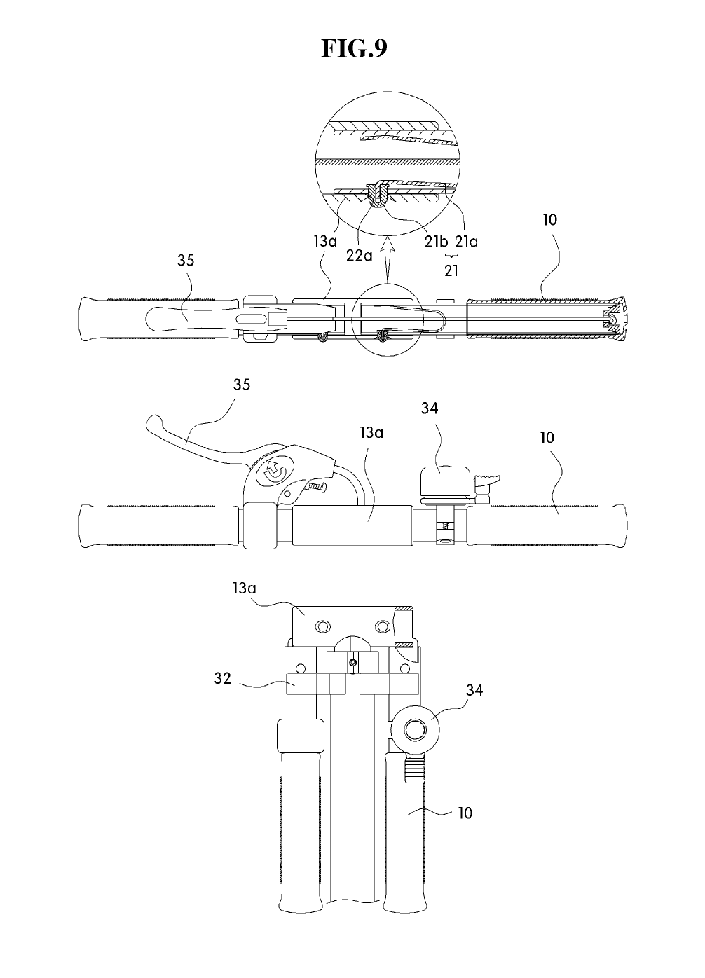

For this end, as shown in FIG. 9, the handlebar 10 on both sides of the steering unit 14 is coupled through a hinge structure to a horizontal pipe member provided on the top of the steering column 13—that is, on the top end of the upper steering column 13a, and is foldable downward about the hinge coupled portion so as to be folded in parallel to both sides of the steering column 13.

A handlebar 10 folded in this state is inserted in a handle holder 33 provided at the top of the upper steering column 13a and does not move.

Here, the hinge member for folding the handlebar 10 may be a resilient stopper 21.

In particular, a spring member 21a has one end thereof fixed in the pipe of the handlebar 10 in a bent shape to apply tension, and the other end of the spring member 21a has a hinge pin member 21b mounted thereto.

Therefore, the hinge pin member 21b that receives constant tension from the spring member 21a is inserted in a hole 22a in the steering column 13 to perform the function of a hinge axis. The handlebar 10 is then folded downward or straightened to a horizontal position about the hinge pin member 21b acting as a pivoting axis.

Reference numeral 35 in FIG. 9 represents a brake lever.

A stand 12 is provided to support the steering unit 14 and connect it to a board plate 19.

The stand 12 is configured of a cylindrical pipe member that receives the pivoting shaft 26 of the steering unit 14, and an angled pipe member integrally formed at a certain angle to the cylindrical pipe member. The cylindrical pipe member supports the steering unit 14, and the angled pipe member is used to connect to the board plate 19.

Accordingly, the steering unit 14 and board plate 19 are connected by the stand 12 to form a single integrated board.

In particular, a structure is provided in which the entire steering unit 14 including the handlebar 10 and the front wheel 11 can be folded toward the board plate 19, so that the overall volume of the board may be significantly reduced.

For this purpose, the bottom of the angled pipe member of the stand 12 is coupled by means of a hinge pin 28 to the front board plate 15 of the board plate 19, thus providing a structure in which the stand 12 including the steering unit 14 can be pivoted in its entirety.

Also, a pair of guide walls 30 having arcuate slots 29 are erected at a certain distance apart from one another on the top surface of the front board plate 15. The angled pipe members of the stand 12 are received between the erected guide walls 30, so as to enable the stand to be guided by the guide walls 30 when pivoted to be folded.

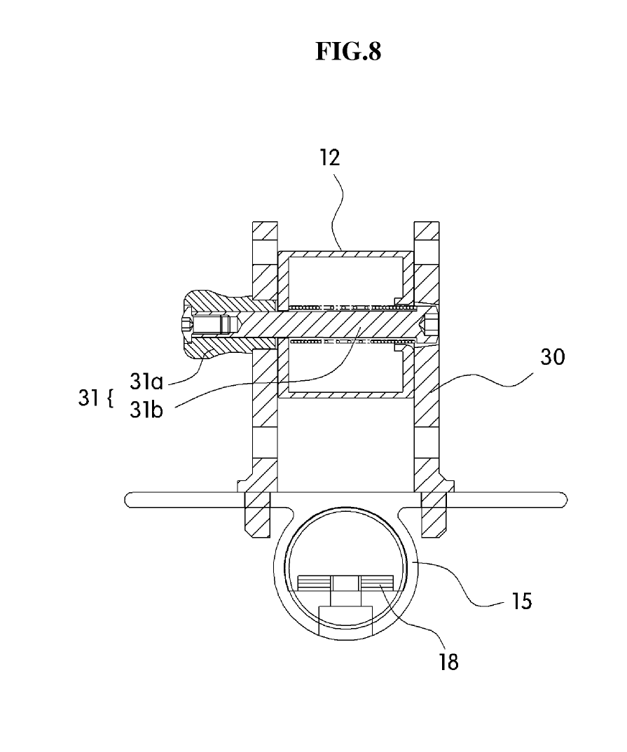

Also, as shown in FIG. 8, a locking pin 31 is provided to pass horizontally through both the guide walls 30 and the angled pipe members therein. The locking pin 31 is configured of a knob 31a and pin 31b, and is inserted through the slots 29. A spring is attached on the periphery of the pin 31b of the locking pin 31 disposed in the space between the angled pipe members, so as to resiliently support the locking pin 31 in one direction.

Here, the knob 31a of the locking pin 31 is a portion that may be grasped by hand, and by grasping the knob 31a and pulling the locking pin 31, the locking pin 31 and slots 29 may be disengaged from one another.

For example, the slots 29 formed in the guide walls 30 are formed in a pair of parallel slots with one above the other. Here, the upper slot 29a is a slot with a single width to function as a guiding passage for the movement of a guide pin 23, and the lower slot 29b is formed to have a width at either end thereof that is greater than the section therebetween, in order to allow the end of the knob 31a of the locking pin 31 with a greater diameter than the middle of the slot to catch on the end portions of the lower slot that are formed as round knob seating holes 32, in which the knob 31a is caught to retain the locking pin 31.

Accordingly, when a user pulls the knob 31a of the locking pin 31, the end of the knob 31a is released from the knob seating hole 32, and the retention of the stand 12 is released by the locking pin 31, so that the entire stand 12 including the steering unit 14 pivots about the hinge pin 28 and may be folded. From this folded state, when the knob 31a of the locking pin 31 is released, the force of the spring restores the end of the knob 31a so that it catches in the knob seating hole 32, whereupon the folded state can be maintained.

The multi-purpose board includes a board plate 19 that enables a user to place both feet thereon to ride the board.

The board plate 19 is configured of a front board plate 15 with a narrow area supporting the end of the steering unit 14, and a rear board plate 17 with a wider area for supporting a user's feet. The front board plate 15 and rear board plate 17 are integrally connected by means of a spring 18 to enable forward movement of the board by means of twisting and restoration of the spring 18.

Here, the spring 18 is formed with multiple sheets of elongated bar-shaped leaf springs, which are aligned within the front board plate 15 and the rear board plate 17 and have either end thereof fastened by a bolt, rivet, etc. on each board plate, so as to provide power to move the board forward through twisting and restoring of the spring due to movement of the board plates or movement of the handlebar 10.

Also, the front board plate 15 and rear board plate 17 are aligned one behind the other and separated a certain distance apart. Thus, the spring 18 connecting the two board plates is exposed therebetween, and the exposed periphery of the spring 18 is covered by a zabala-type cover 27.

Further, 2 rear wheels 16 are installed to be capable of pivoting 360° on the end of the rear board plate 17 in order to provide free movement to the rear board plate 17.

The rear wheels 16 capable of pivoting 360° provide the effect, together with the front wheel 10 that pivots to the left and right, of giving the board freedom in changing directions.

For example, for conventional boards, both feet are used (S-boards), in the case of tri-boards, their considerable size necessitates a large turning circle, and kickboards also have a large turning circle because only the front wheel pivots to the left and right while the rear wheel is fixed.

However, with the multi-purpose board according to the present invention, because the front wheel is pivotable to the left and right and the rear wheels are pivotable 360°, directional sense becomes natural, and the board may be operated safely and freely.

Accordingly, a description of the thus-configured multi-purpose board in use will be provided.

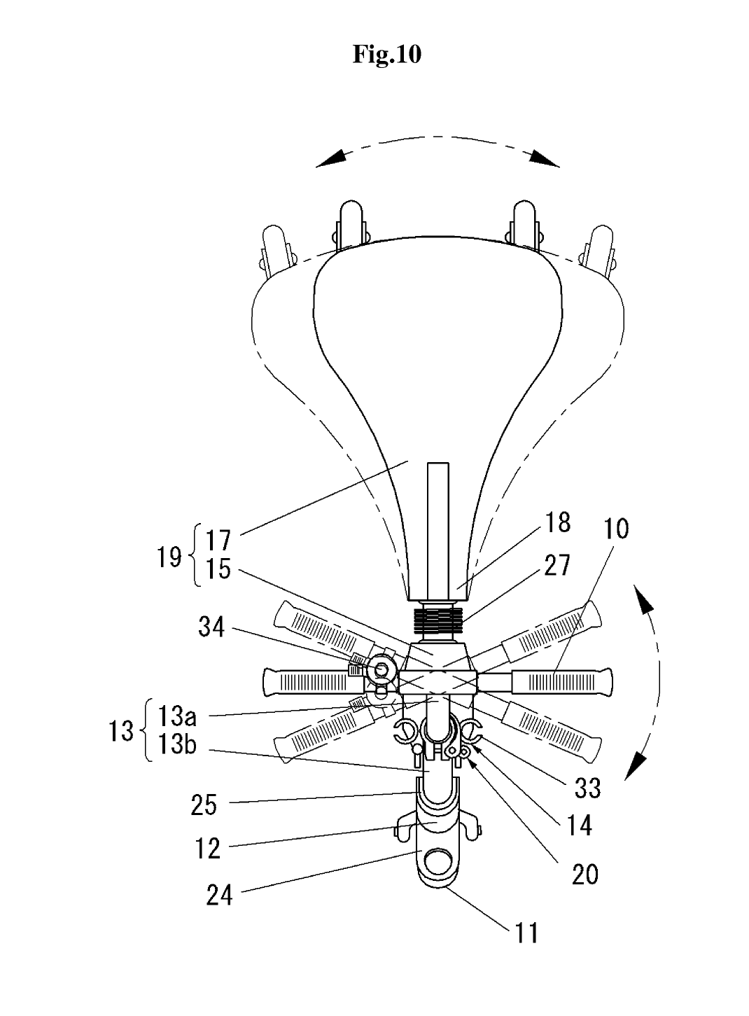

FIG. 10 is a plan view illustrating a multi-purpose board being used according to an embodiment of the present invention.

Referring to FIG. 10, the multi-purpose board is driven by grasping the handlebar 10 with both hands, placing both feet on the board plate 19, and moving one's legs or buttocks, waist, and both arms.

Body movements for each mode of riding the multi-purpose board are as follows.

First, when initially starting as in a kickboard, both hands grasp the handlebar 10, and one foot is used to push against the ground in order to move forward, with the other foot placed on the board plate 19.

Next, after starting off as a kickboard or in order to move from a standstill with two feet placed on the board plate 19, the buttocks, thighs, and other parts of the lower body are undulated while the undulations are relayed to both legs. At this point, both rear wheels 16 are naturally pivoted to the left and right to propel the board forward.

This is similar to the moving principle of a conventional tri-board.

Then, when changing to whole-body exercise after accelerating from a standstill by using the lower body, when speed begins to build while using the lower body, the handlebar 10 is undulated laterally as in rowing to impart twist and restoration of the spring 18 to accelerate by 2 to 3-fold or more, thereby giving the user excitement and thrill from riding the board.

This is a similar moving principle to that of the S-board.

Thus, according to the multi-purpose board of the present invention which suitably combines the merits of conventional exercise devices, exercise can be performed as when riding a kickboard, S-board, tri-board, etc. while enjoying the sensation of speed; and depending on need, a user can selectively enjoy the functions of a kickboard, an S-board, and a tri-board, and derive more enjoyment in riding the board and exercising effects.

A multi-purpose board according to the present invention has the following effects.

First, entire body exercise can be performed through lower body movement of using the buttocks and thighs to move the board laterally, and upper body movement of using both arms to move the handlebar to the left and right.

Second, one can experience both excitement and thrill from using the lower body from a standstill and then after accelerating, rowing the handlebar left and right, which results in a 2 to 3-fold increase in speed by means of the twisting and restoring of the spring.

Third, because the riding method of the multi-purpose board is to grasp the handlebar and move both the upper and lower body, a sense of balance is maintained while retaining a stable position, which enables beginners to ride the multi-purpose board.

Fourth, because both the handlebar and steering column can be folded, the overall volume and size of the board can be reduced, thereby facilitating storage and maintenance and making carrying convenient.

Fifth, because the front wheel moves to the left and right, and the rear wheels can rotate 360°, the multi-purpose board can be operated safely yet freely, and allows for freedom in selecting direction, and because the turning radius is small, changing direction is very easy.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A multi-purpose board comprising:
a steering unit, being a member for controlling a direction of a front wheel pivoting shaft to change a travelling direction of the multi-purpose board, and comprising a handlebar at a top thereof, a front wheel at a bottom thereof, and a steering column pivotably inserted in a board plate-end stand;
a board plate, being a portion upon which a user positions feet for riding, and comprising a rear board plate having a rear wheel capable of rotating 360° with respect to a front board plate connected to the stand, and a spring connecting the front board plate and the rear board plate in-line from front to rear and for enabling forward movement of the multi-purpose board by means of being twisted and restored; and
a lock/unlock device provided on a top of a lower steering column to fix a stored and extracted state of an upper steering column, the steering column of the steering unit comprising the upper steering column and the lower steering column, and the upper steering column being storable within and extractable from the lower steering column, wherein
the upper steering column of the steering unit comprises a resilient stopper having a spring member fixed at one end thereof to an inside of a pipe and bent to impart tension, and a hinge pin member installed on the other end of the spring member to receive outward tension and be inserted into a hole defined in the lower steering column.

2. The multi-purpose board of claim 1, wherein the handlebar at both sides of the steering unit is coupled as a hinged structure to the steering column via the resilient stopper so as to be foldable downward to be parallel along both sides of the steering column.

3. The multi-purpose board of claim 2, wherein the resilient stopper for folding the handlebar comprises:
the spring member fixed at the one end thereof to the inside of the pipe and bent to impart tension; and
the hinge pin member installed on the other end of the spring member to receive outward tension and be inserted into the hole defined in the steering column.

4. The multi-purpose board of claim 1, wherein the lower steering column of the steering unit is coupled to the front wheel by a pivoting shaft disposed concentrically within the stand with a bearing therebetween, a bottom of the pivoting shaft is coupled to a front wheel fork, and a top of the pivoting shaft is coupled to the lower steering column through a clamp.

5. The multi-purpose board of claim 1, wherein the spring connecting the front board plate and the rear board plate is configured of a plurality of stacked sheets of elongated bar-shaped leaf springs.

6. The multi-purpose board of claim 1, wherein the front board plate and the rear board plate are separated by a predetermined distance, and a periphery of the spring that is exposed therebetween is finished with a zabala-shaped cover.

7. The multi-purpose board of claim 5, wherein the front board plate and the rear board plate are separated by a predetermined distance, and a periphery of the spring that is exposed therebetween is finished with a zabala-shaped cover.

8. The multi-purpose board of claim 1, wherein the board plate and the stand are coupled with a hinge pin, the stand is received between a pair of guide walls installed on the board plate and having arcuate slots, and the steering unit comprising the stand is entirely foldable against the board plate, by virtue of being guided by a locking pin that passes through the guide walls and the stand and moves along the slots, such that the steering unit is foldable forward and backward.

9. The multi-purpose board of claim 8, wherein the slot in the guide wall is disposed as a parallel pair of one above another, of which an upper slot is formed in a single width to provide a guiding passage, and a lower slot has widths at both ends thereof greater than a width between the ends thereof to provide locking sections.
